(19) United States
(12) Patent Application Publication
(10) Pub. No.: US 2005/0111757 A1
(43) Pub. Date: May 26, 2005

(54) Auto-image alignment system and method based on identified anomalies

(76) Inventors: Charles Cameron Brackett, Overland Park, KS (US); Steven Lawrence Fors, Chicago, IL (US); Mark M. Morita, Arlington Heights, IL (US)

Correspondence Address: Patrick S. Yoder;FLETCHER YODER, P.O. Box 692289, Houston, TX, 77269-2289, US

(21) Appl. No.: 10/723,789

(22) Filed: Nov. 26, 2003

(51) Int. Cl. G06K 9/32; G06K 9/00

(52) U.S. Cl. 382/294; 382/128

(57) ABSTRACT

The present invention provides a novel technique and is particularly useful in medical imaging, although a number of fields may benefit from its application. In one aspect of the technique, a user identifies anomalies or, more generally, features in at least two different comparable images either by computer aided techniques or by manual identification. Once the features are identified they are numbered, sized, and a key location for the feature, such as the middle of an anomaly, may be estimated. Once this location is determined, a location marker is used to perform registration of the images. When comparisons are to be conducted, then, the registration is used to effectively anchor the images with respect to one another to facilitate paging between the images and reduction of eye movement.

### BACKGROUND OF THE INVENTION

The present invention relates generally to the field of image analysis systems, such as systems used for medical diagnostic purposes and other purposes. More particularly, the invention relates to a technique for registering images with one another, particularly images generated at separate times, to facilitate analysis of features such as anomalies within the images.

Conventional imaging techniques, such as X-ray techniques, produce high-quality film-based images that are reproduced for reading by users. Other conventional approaches provide images supported on paper, and images displayed on computer screens. Many systems can produce all or more than one of these types of presentations. In the medical diagnostics field, for example, it has been conventional for X-ray images to be reproduced on film, and it is increasingly common to see such images displayed on high-resolution computer screens.

In analyzing such images, a user will tend to focus upon one or more particular features of interest within the image, and may use various techniques for zooming in on the feature, cutting the feature, or otherwise highlighting the feature for analysis. In medical imaging, for example, radiologists and clinicians will typically identify anomalies in anatomical images based upon high-quality film or computer-based presentations. Where computer presentation is utilized, various “hanging protocols” may be employed to effectively simulate the manner in which film is hung for reading by a radiologist. The radiologist identifies the anomalies by experience, and may be supported by computer-based algorithms which can at least partially identify and segment the anomalies, or otherwise highlight them for the radiologist's review.

A problem arising in digital reading in images is the ability to register a historical image with a respective current image. In medical imaging, for example, breast images may be created at different points in time, and may be used to analyze whether an anomaly has come into existence or has progressed, responded to treatment, or otherwise changed over time. Current techniques include providing side-by-side presentation for comparison purposes, or stacked approaches with a current image on top and historical images below. To move through time, the user may, in a computer setting, press a key, such as a down arrow, to pace through historical images, thereby somewhat minimizing eye movement from one image to the other. With this stacked approach, although eye movement is reduced, it is not optimized due to misalignment between the images in the various views. That is, the physician still is required to move his regard from side-to-side, or up and down to register the eyes with the anomaly. With each image, the user effectively memorizes the anomaly, then begins mental clinical comparisons based upon the memorized views.

An improved technique is needed for facilitating review of multiple images, particularly images presented in a computerized format and generated at different points in time. While such techniques may find use in many different settings, there is a particular need at present for approaches to viewing time-based medical images which facilitates reading by a radiologists or technician.

### BRIEF DESCRIPTION OF THE INVENTION

The present invention provides a novel technique designed to respond to such needs. The technique is particularly useful in medical imaging, although a number of fields may benefit from its application. In one aspect of the technique, a user identifies anomalies or, more generally, features in at least two different comparable images either by computer aided techniques or by manual identification. Once the features are identified they are numbered and sized. The sizing of the features may be used to estimate a key location for the feature, such as the middle of an anomaly. Once this location is determined, a location marker is used to perform registration of the images. When comparisons are to be conducted, then, the registration is used to effectively anchor the images with respect to one another to facilitate paging between the images and reduction of eye movement. Multiple such anchors may be used in a particular image, and, where desired, the user may select which location is to be used as a reference in paging through the images.

Aspects of the invention provide a method for aligning images, including identifying a feature of interest in a first image, identifying a corresponding feature of interest in a second image, registering the feature of interest within the first image with the corresponding feature of interest within the second image, and storing and displaying registration data corresponding to registration. Displaying the registration data may include displaying a cine serial view of the first image and the second image, displaying an overlay of the first image and second image in stack mode, and displaying a composite image of the first image and the second image.

Other aspects of the invention provide a method for registering images, including segmenting a feature of interest in a first image, segmenting a corresponding feature of interest in a second image, registering the first image with the second image by aligning the feature of interest with the corresponding feature of interest, and storing image data corresponding to registration. The first image and second image may be acquired in different temporal settings and acquired by the same or different modalities. Additionally, the first image and second image may be X-ray images. Moreover, the registration data may be displayed as a cine serial display, an overlay in stack mode, and a composite image.

Yet other aspects of the invention provide a method for registering images, including segmenting a feature of interest in a first image, segmenting a corresponding feature of interest in a second image, determining a first reference point on the feature of interest in the first image, determining a second reference point on the corresponding feature of interest in the second image, registering the first image with the second image based on alignment of the first reference point with the second reference point, and storing registration data corresponding to registration. The method may further include displaying the registration data in at least one of a cine serial display, an overlay in stack mode, and a composite image. Moreover, the feature of interest and the corresponding feature of interest may be an anomaly, and the first reference point may be the middle of the feature of interest and the second reference point may be the middle of the corresponding feature of interest. Additionally, the first image and the second image are acquired in different temporal settings, and the segmenting and/or registering may be automated. The method may further include determining additional reference points and registering the first image with the second image based on the additional reference points.

In accordance with aspects of the invention, a method for anchoring images includes identifying and sizing a feature of interest in a first image, identifying and sizing a corresponding feature of interest in a second image, locating a first reference point on the feature of interest, locating a second reference point on the corresponding feature of interest, registering the first image with the second image based on anchoring the first reference point with the second reference point, and storing registration data corresponding to registration. One or more computer aided techniques may be used to identify and size the feature of interest and the corresponding feature of interest. Additionally, the feature of interest and the corresponding feature of interest may be manually identified. Moreover, the first reference point and the second reference point may be location markers for the registration, and the registration may include a rigid body registration transformation (i.e., a translation, a rotation, a magnification, and/or a shearing), a warped registration (i.e., an elastic transformation, a multi-scale approach, a multi-region approach, and/or a pyramidal approach), and a combination of a rigid body registration and a warped registration. The technique may further provide for accessing the registration data to compare the first image with the second image, accessing the registration data to compare the feature of interest with the corresponding feature of interest, and displaying the registration data in at least one of a cine serial display, an overlay in stack mode, and a composite image.

Aspects of the invention provide for a system for registering images including one or more imaging systems for acquiring and storing images, a first interface for accessing, reviewing, processing and registering the images, a storage for storing image registration data, and wherein registration of the images is based on alignment of corresponding features of interest in the images. The system may further include a second interface or monitor for displaying the registration data in at least one of a cine, a stack, an overlay, and a composite. Additionally, the first interface and the second interface may be the same PACS workstation. The system may further include an analog to digital device or scanner for converting analog film images to digital images. In general, the images may be digital images (digitally-acquired images) and/or digitized images (scanned images). The one or more imaging systems may be a conventional X-ray imaging system, a digital X-ray imaging system, a CT imaging system, a MR imaging system, and so forth.

Facets of the invention also provide a system for comparing images, including means for identifying a feature of interest in a first image, means for identifying a corresponding feature of interest in a second image, means for registering the feature of interest within the first image with the corresponding feature of interest within the second image, means for storing registration data corresponding to registration, and means for displaying the registration data in cine serial view, stack mode, as an overlay, as a composite, and the like. Other facets of the invention provide a system for registering images, including means for segmenting a feature of interest in a first image, means for segmenting a corresponding feature of interest in a second image, means for registering the first image with the second image by aligning the feature of interest with the corresponding feature of interest, means for storing image data corresponding to registration, and means for displaying the image data corresponding to registration. Yet other facets of the invention provide a system for aligning images, including means for segmenting a feature of interest in a first image, means for segmenting a corresponding feature of interest in a second image, means for determining a first reference point on the feature of interest in the first image, means for determining a second reference point on the corresponding feature of interest in the second image, means for registering the first image with the second image based on alignment of the first reference point with the second reference point, means for storing registration data corresponding to registration, and means for displaying the registration data.

In accordance with aspects of the invention, a computer program, provided on one or more tangible media, for registering images, includes a routine for identifying a feature of interest in a first image, a routine for identifying a corresponding feature of interest in a second image, a routine for registering the feature of interest within the first image with the corresponding feature of interest within the second image, a routine for storing registration data corresponding to registration, and a routine for displaying the registration data in a cine serial view, a stack mode, an overlay, and a composite image. Other aspects of the invention give a computer program, provided on one or more tangible media, for comparing images, and which includes a routine for segmenting a feature of interest in a first image, a routine for segmenting a corresponding feature of interest in a second image, a routine for registering the first image with the second image by aligning the feature of interest with the corresponding feature of interest, a routine for storing image data corresponding to registration, and a routine for displaying the image data corresponding to registration. Facets of the invention may also provide a computer program for aligning images, including a routine for segmenting a feature of interest in a first image, a routine for segmenting a corresponding feature of interest in a second image, a routine for determining a first reference point on the feature of interest in the first image, a routine for determining a second reference point on the corresponding feature of interest in the second image, a routine for registering the first image with the second image based on alignment of the first reference point with the second reference point, a routine for storing registration data corresponding to registration, and a routine for displaying the registration data.

### BRIEF DESCRIPTION OF THE DRAWINGS

FIG. 1 is a general diagrammatical representation of certain functional components of an exemplary image data-producing system, in the form of a medical diagnostic imaging system;

FIG. 2 is a diagrammatical representation of a particular imaging system of the type shown in FIG. 1, in this case an exemplary digital X-ray imaging system;

FIG. 3 is a diagrammatical representation of a digital X-ray image of a breast with an anomaly at time t₁ acquired with the type of system depicted in FIG. 2;

FIG. 4 is a diagrammatical representation of a digital X-ray image of the same breast and anomaly of FIG. 3, but acquired at time t₂;

FIG. 5 is a diagrammatical representation of a digital composite image of an overlay of the temporal images of FIGS. 3 and 4;

FIG. 6 is a diagrammatical representation of image data of the identified anomaly extracted from the temporal images depicted in FIGS. 3 and 4;

FIG. 7 is a diagrammatical representation of a digital composite image of an overlay and registration of the temporal images of FIGS. 3 and 4, the registration based on aligning the anomaly in the two temporal images; and

FIG. 8 is a block diagram of an image registration method that aligns images based on the location of an anomaly or on the location of a reference point on the anomaly.

### DETAILED DESCRIPTION OF SPECIFIC EMBODIMENTS

The present technique facilitates comparison of digital images acquired at different times. A clinician may analyze a time series of medical images for the presence of one or more indicia of medical pathologies such as nodules, lesions, fractures, microcalcifications, and the like. In general, the clinician may focus on one or more features such as an anomaly within the images and how those features change over time. Of course, certain imaging modalities may be better suited for detecting different types of features.

Imaging modality resources may be available for analyzing features and specific anatomies, as well as, for diagnosing medical events and conditions in both soft and hard tissue. Such medical imaging resources or systems may include modalities such as X-ray, Computed Tomography (CT), Magnetic Resonance Imaging (MRI), Positron Emission Tomography (PET), thermoacoustic imaging, optical imaging, nuclear medicine-based imaging, and so forth. Throughout the discussion, it should be borne in mind that the present techniques may be applied to image data produced by any such system or modality, and is generally independent of the system or modality used to acquire the image data. That is, the technique may operate on stored raw, processed or partially processed data from any suitable source.

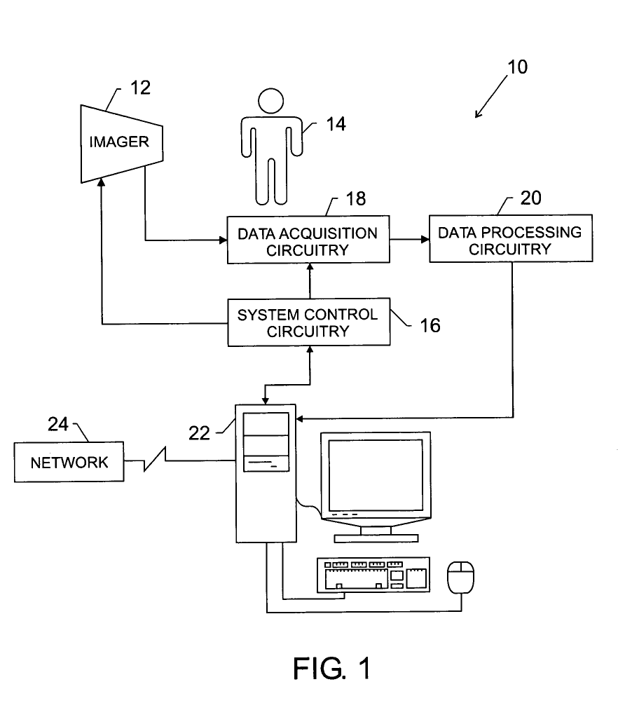

Turning now to the drawings, and referring initially to FIG. 1, an overview of an imaging system 10 which may be representative of various imaging modalities is depicted. An imaging system 10 generally includes some type of imager 12 which detects signals and converts the signals to useful data. As described more fully below, the imager 12 may operate in accordance with various physical principles for creating the image data. In general, however, in image data indicative of regions of interest in a patient 14 are created by the imager either in a conventional support, such as photographic film, or in a digital medium.

The imager 12 operates under the control of system control circuitry 16. The system control circuitry may include a wide range of circuits, such as radiation source control circuits, timing circuits, circuits for coordinating data acquisition in conjunction with patient or table of movements, circuits for controlling the position of radiation or other sources and of detectors, and so forth. The imager 12, following acquisition of the image data or signals, may process the signals, such as for conversion to digital values, and forwards the image data to data acquisition circuitry 18. In the case of analog media, such as photographic film, the data acquisition system may generally include supports for the film, as well as equipment for developing the film and producing hardcopies that may be subsequently digitized. For digital systems, the data acquisition circuitry 18 may perform a wide range of initial processing functions, such as adjustment of digital dynamic ranges, smoothing or sharpening of data, as well as compiling of data streams and files, where desired. The data are then transferred to data processing circuitry 20 where additional processing and analysis are performed. For conventional media such as photographic film, the data processing system may apply textual information to films, as well as attach certain notes or patient-identifying information. For the various digital imaging systems available, the data processing circuitry 20 may perform substantial analyses of data, ordering of data, sharpening, smoothing, feature recognition, and so forth.

Ultimately, the image data are forwarded to some type of operator interface 22 for viewing and analysis. While operations may be performed on the image data prior to viewing, the operator interface 22 is at some point useful for viewing reconstructed images based upon the image data collected. It should be noted that in the case of photographic film, images are typically posted on light boxes or similar displays to permit radiologists and attending physicians to more easily read and annotate image sequences. The images may also be stored in short or long-term storage devices, for the present purposes generally considered to be included within the interface 22, such as picture archiving communication systems. The image data can also be transferred to remote locations, such as via a network 24. It should also be noted that, from a general standpoint, the operator interface 22 affords control of the imaging system, typically through interface with the system control circuitry 16. Moreover, it should also be noted that more than a single operator interface 22 may be provided. Accordingly, an imaging scanner or station may include an interface which permits regulation of the parameters involved in the image data acquisition procedure, whereas a different operator interface may be provided for manipulating, enhancing, and viewing resulting reconstructed images.

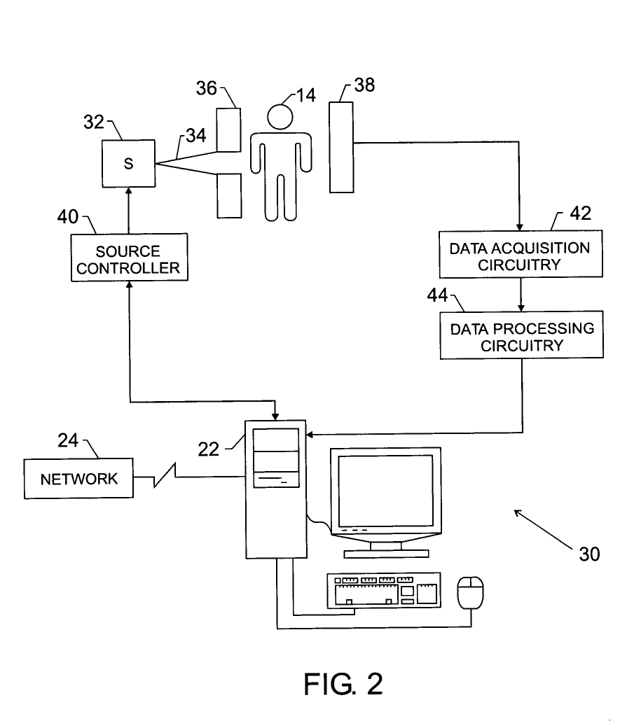

To discuss the technique in greater detail, a specific medical imaging modality based upon the overall system architecture outlined in FIG. 1 is depicted in FIG. 2, which generally represents a digital X-ray system 30. It should be noted that, while reference is made in FIG. 2 to a digital system, the present technique also encompasses conventional X-ray systems, as well as, other imaging modalities. Conventional X-ray systems, for example, may offer extremely useful tools both in the form of photographic film, and digitized image data extracted from photographic film, such as through the use of a digitizer.

System 30 includes a radiation source 32, typically an X-ray tube, designed to emit a beam 34 of radiation. The radiation may be conditioned or adjusted, typically by adjustment of parameters of the source 32, such as the type of target, the input power level, and the filter type. The resulting radiation beam 34 is typically directed through a collimator 36 which determines the extent and shape of the beam directed toward patient 14. A portion of the patient 14 is placed in the path of beam 34, and the beam impacts a digital detector 38.

Detector 38, which typically includes a matrix of pixels, encodes intensities of radiation impacting various locations in the matrix. A scintillator converts the high energy X-ray radiation to lower energy photons which are detected by photodiodes within the detector. The X-ray radiation is attenuated by tissues within the patient, such that the pixels identify various levels of attenuation resulting in various intensity levels which will form the basis for an ultimate reconstructed image.

Control circuitry and data acquisition circuitry are provided for regulating the image acquisition process and for detecting and processing the resulting signals. In particular, in the illustration of FIG. 2, a source controller 40 is provided for regulating operation of the radiation source 32. Other control circuitry may, of course, be provided for controllable aspects of the system, such as a table position, radiation source position, and so forth. Data acquisition circuitry 42 is coupled to the detector 38 and permits readout of the charge on the photo detectors following an exposure. In general, charge on the photo detectors is depleted by the impacting radiation, and the photo detectors are recharged sequentially to measure the depletion. The readout circuitry may include circuitry for systematically reading rows and columns of the photo detectors corresponding to the pixel locations of the image matrix. The resulting signals are then digitized by the data acquisition circuitry 42 and forwarded to data processing circuitry 44.

The data processing circuitry 44 may perform a range of operations, including adjustment for offsets, gains, and the like in the digital data, as well as various imaging enhancement functions. The resulting data are then forwarded to an operator interface or storage device for short or long-term storage. The images reconstructed based upon the data may be displayed on the operator interface, or may be forwarded to other locations, such as via a network 24, for viewing. Also, digital data may be used as the basis for exposure and printing of reconstructed images on a conventional hard copy medium such as photographic film.

When in use, the digital X-ray system 30 acquires digital X-ray images of a portion of the patient 14 which may then be analyzed for the presence of anomalies or indicia of one or more medical pathologies. In practice, a clinician may initially review a medical image, such as an X-ray, and detect features or features of diagnostic significance, such as an anomaly, within the image. As previously mentioned, to facilitate analysis of the features, the clinician may retrieve earlier collected images of the same patient, and compare images generated at separate times. Such a comparison may be facilitated, for example, by registration of the images.

Image-based registration may take a variety of forms, such as extrinsic methods, based on foreign objects introduced into the imaged space, intrinsic methods based on the image information as generated by the patient, and other methods. Extrinsic methods may rely on artificial objects attached to the patient, objects which are designed to be visible and detectable in given modalities. Extrinsic registration, however, may have drawbacks with the prospective character of the pre-acquisition phase and the often invasive character of the marker objects. Non-invasive markers may be used but are generally less accurate. In contrast, an advantage of intrinsic methods is that they may rely on patient generated image content only. In other words, with intrinsic methods, registration can be based on a limited set of identified salient points or landmarks, segmentation-based alignments, measures computed from the image pixel gray values, a combination of these approaches, and so forth. Segmentation based registration methods may be rigid model based, where anatomical structures are extracted from both images to be registered, and used as sole input for the alignment procedure. On the other hand, segmentation methods may be deformable model based, where an extracted structure from one image may be elastically deformed to fit the second image.

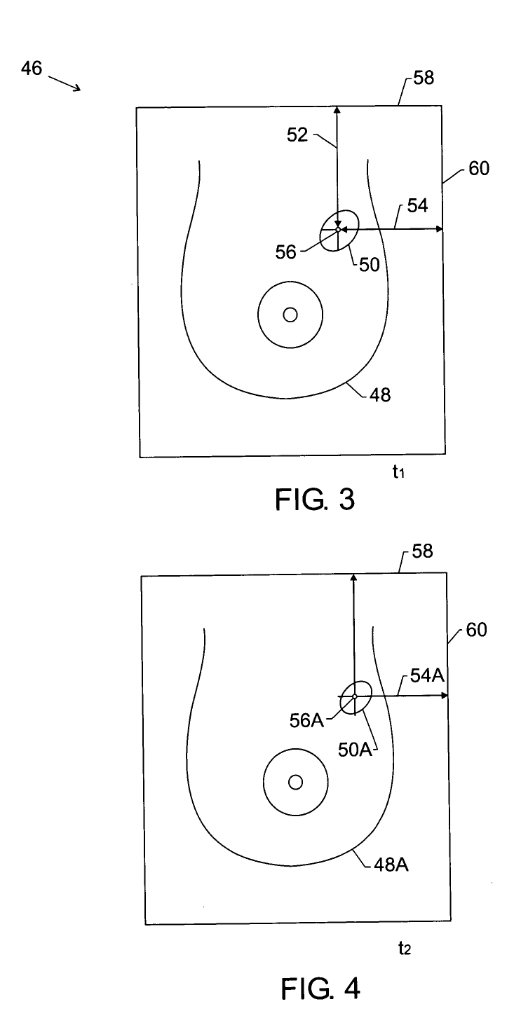

FIG. 3 is a diagrammatical representation of a typical digital X-ray image 46 acquired at time t₁ of a breast 48 with an anomaly 50. Image 46 is the type of image that may be acquired, for example, by the digital X-ray system depicted in FIG. 2. The Y distance 52 and X distance 54 represent the coordinate lengths from the midpoint 56 of the anomaly 50 to the top edge 58 and right edge 60 of the image 46, respectively.

Similarly, FIG. 4 is a diagrammatical representation of a digital X-ray image 46A of the same breast 42A and anomaly 50A of FIG. 3, but acquired at time t₂ The Y distance 52A and the X distance 54A in FIG. 4 correspond descriptively to the Y distance 52 and the X distance 54 of FIG. 3. The magnitudes of these respective dimensions, however, in this example, have changed over time and are different at time t₂ relative to t₁. It should be emphasized that the illustration of an anomaly in FIGS. 3 and 4 is only given as an example, and that the present technique may apply to features and structures of interest in general. Additionally, reference points other than the midpoint may be used as a marker for registration.

In the illustrative embodiment of FIGS. 3 and 4, the images 46 and 46A may represent images of the same patient's breast 48 and 48A acquired by the same modality but in different temporal settings or different sessions, representing, for example, a radiologist's comparison of a current X-ray image versus a historical X-ray image. The present technique, however, may also be applicable to the comparison or registration of images of a patient acquired in the same temporal setting, such as may be desirable where the patient move or changed positions between acquisition of the images. Additionally, it is worth noting that the technique may also apply to images acquired with modalities other than digital X-ray, as well as, to images acquired by different modalities, such as in the registration, for example, of an MR image with an X-ray image. Also, other aspects of the present technique may be apparent, such as its applicability to registration of a patient image with a clinical reference image, its applicability to one or more features or anomalies in a given image, and so forth.

As previously discussed, in general, a clinician, such as a physician or radiologist, may initially review a medical image and detect features or features of diagnostic significance, such as an anomaly, within the image. The radiologist may identify anomalies by experience, and may utilize computer-based algorithms which can at least partially identify and segment the anomalies, or otherwise highlight them for the radiologist's review. Again, to facilitate analysis of the features, the clinician may retrieve earlier collected images of the same patient, and compare images generated at separate times in different temporal settings, such as a comparison of current images version historical. In practice, a time series of images may be obtained for a variety of reasons, such as monitoring of bone growth in children, monitoring of tumor growth, post-operative monitoring of healing, and so forth.

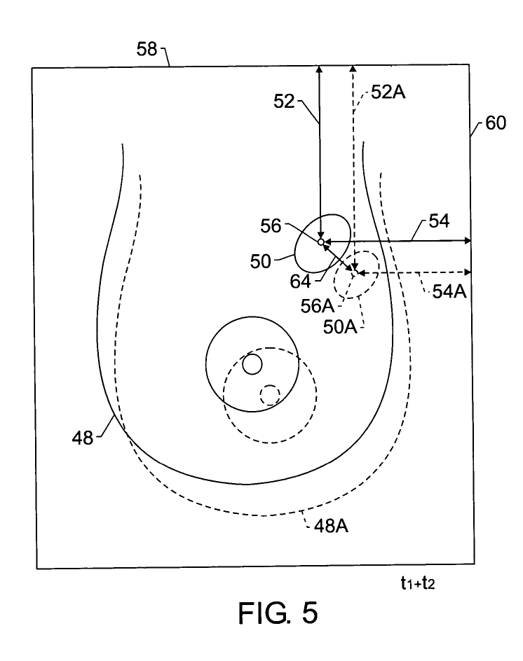

FIG. 5 is a diagrammatical representation of a digital composite image 62 of an overlay of the images 46 and 46A of FIGS. 3 and 4 prior to registration. In this exemplary temporal comparison of images of a patient's breast 48 and 48A, the offset 64 of the midpoints 56 and 56A of the anomaly 50 and 50A may be related, for example, to changes that occur over time, such as changes in patient weight, other physiological changes in the patient, and so forth. The offset 64 may also result from temporal variations in the patient setting, as well as, factors other than patient physiology or patient setting. Nevertheless, application of the present technique does not necessarily depend on the causes of the offset 64. A valuable aspect of the technique is to mitigate or address undesirable effects of the offset 64 on a clinician's comparison of the two images.

For images that vary with time, as well as, images that may vary spatially due to, for example, patient movement, comparison of the images may be facilitated by registration of the images. Of course, registration may be more or less beneficial depending on the circumstances. For example, with a time series of images, registration may more advantageous with longer time intervals between acquisitions of the images. For images acquired in the same temporal setting, registration may be beneficial, for example, where the patient leaves the scanner or imager between acquisitions of the images. It should be noted the present techniques applies to a wide variety of registration applications, such as registration of images acquired by the same or different modalities during the same or different temporal settings. Again, the technique may also apply to registration of a patient image with a clinical reference image.

Registration of the two images 46 and 46A may be used to reduce or eliminate the offset 64 in the composite image between the locations of the midpoint 56 and 56A, and thus facilitate comparison of the two images in stack mode, or as an overlay or composite image, in cine mode, and so forth. It should be apparent that the present technique may also apply to more than two images, which may prove advantageous, for example in the comparison of multiple images in cine mode (i.e., cine serial view or cine serial display), as well as in stack mode, or as one or more composite images. In sum, registration of the two temporal images 46 and 46A by the alignment of the two temporal locations of the midpoint 56 and 56A may facilitate comparison, especially in the analysis of a change over time in a feature of interest (i.e., anomaly 50 and 50A). To accomplish registration, the anomaly 50 and 50A may be identified in both temporal images 46 and 46A, for example, by segmentation, and then sized to locate the midpoint 56 and 56A. The temporal images 46 and 46A may then be registered based on the temporal locations of the midpoint 56 and 56A.

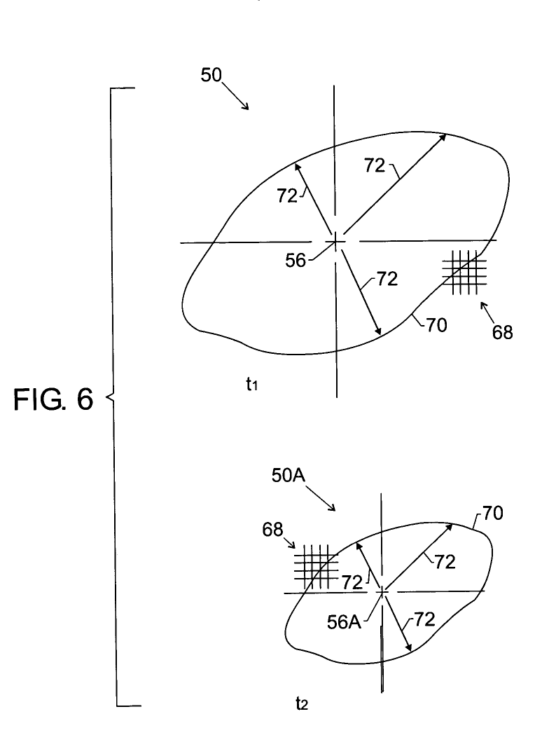

FIG. 6 is a diagrammatical representation of two extracted images 66 of the identified anomaly 50 and 50A within the temporal images 46 and 46A acquired at t1 and t2, respectively. In this embodiment, the feature of interest (anomaly 50 and 50A) was extracted from the overall images 46 and 46A via a segmentation algorithm. A variety of procedures, however, other than segmentation may be used to extract a feature from its background. Additionally, it should be noted that in feature analysis, a radiologist or physician may first consider a hard copy of display of an image to discern characteristic features of interest. Also, for digital analyses, various computer-assisted detection (CAD) algorithms for purposes other than extraction, such as for classification, may be employed. Finally, post-extraction processing of the feature may be determined at the discretion of and based upon the expertise of the practitioner.

For identification and extraction of the anomaly 50 and 50A, a segmentation algorithm may define the boundary of the anomaly based upon calculated features in the image data. The segmentation algorithm may act on an entire data set or on only part of a data set, such as a candidate mass region in a specific area. The particular segmentation technique may depend upon the features or anomalies to be identified, and may be based upon iterative intensity-gradient thresholding, K-means segmentation, edge detection, edge linking, curve fitting, curve smoothing, two- and three-dimensional morphological filtering, region growing, fuzzy clustering, image/volume measurements, heuristics, knowledge-based rules, decision trees, neural networks, and so forth. Alternatively, the segmentation may be at least partially manual. Automated segmentation may also use prior knowledge such as shape and size of a mass to automatically delineate an area of interest. Additionally, prior to segmentation, the image may be processed to better prepare the image for segmentation, such as in smoothing of the image with a box-car technique, to render the image more robust and less susceptible to noise.

In one embodiment of the present technique, a segmentation algorithm that utilizes iterative, pixel-intensity gradient thresholding is used to identify the boundaries of the feature, such as an anomaly 50 and 50A. These intensities or gray levels of the pixel 68 may represent physical or chemical properties of the anatomical structure in the object. For example, in an image obtained by digitizing an X-ray film, the gray level value of a pixel may represent the optical density of the small square area of the film. In the case of X-ray computed tomography, the gray level value may represent the relative linear attenuation coefficient of the tissue. In magnetic resonance imaging, the gray level may correspond to the magnetic resonance signal response of the tissue. In general, in the segmentation algorithm, the threshold gray level or intensity that separates the feature pixels from “non-feature” pixels, or for example, that separates structure pixels from non-structure pixels, may be iteratively determined. A variety of methods may be used to evaluate the intensity (gray level) gradient between pixels in the image and in the region of interest. On the whole, steeper gradients tend to define a change from structure to non-structure or a change from feature to “non-feature” (i.e., background). For methods based upon the gradient magnitude values, a gradient histogram, such as a bar plot of specific populations of pixels having specific gradient values, may be generated to identify gradient threshold values for separating feature structure from non-structure.

The depicted exemplary images 46 and 46A include a region of interest, specifically an anomaly 50 and 50A, having pixel intensity values (gray level values) that differ from the surrounding regions of the image. Thus, at the edges of the anomaly 50 and 50A, an intensity gradient exists between a pixel 68 on the edge of the anomaly 50 and 50A structure and a pixel 68 outside the anomaly 50 and 50A. The segmentation algorithm may detect these pixel intensity gradients and thus define the boundary 70 of the anomaly 50 and 50A. As will be appreciated by those skilled in the art, the algorithm may, for example, compare a candidate pixel 68 to a surrounding neighborhood of pixels 68 in analysis of the pixel intensity gradients. It should be noted that while reference is made to intensity values within an image, the present technique may also be used to process other parameters encoded for the individual pixels 68 of an image. Such parameters might include frequency or color, not merely intensity.

Once the edges or boundaries of the feature (i.e., anomaly 50 and 50A) have been determined, a location of a reference point, such as the midpoint, on the feature may be determined. In this example, the arrows 68 represent distances from the midpoint 50 and 50A to the boundary of the anomaly 56 and 56A. An algorithm may first size the anomaly 50 and 50A to determine the location of the midpoint 56 and 56a, or some other reference point. Instead, an algorithm may directly determine the midpoint 56 and 56A, without sizing the anomaly 50 and 50A. In the example of using the midpoint 56 and 56A of anomaly 50 and 50A, the location of the midpoint 56 and 56A may be derived by various methods. For example, an algorithm may be employed to determine the midpoint 56 and 56A, or some other reference point, based on an approximate pixel count within the boundary 70 of the anomaly 56 and 56A. Other methods to determine a reference point may include, for example, positioning a central location at the intersection of coordinate lines drawn tangentially to the boundary 70 of the anomaly 50 and 50A. It should be apparent, however, that advantages of the present technique do not depend on the method of determining the midpoint 56 and 56A or other location markers.

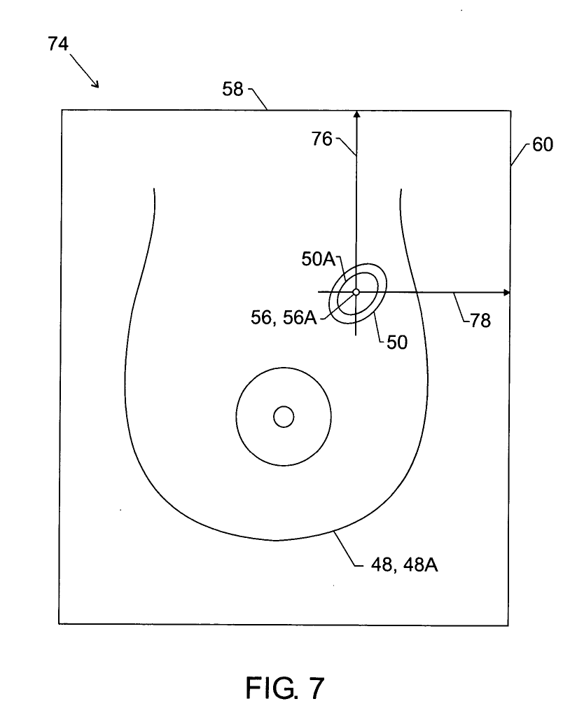

FIG. 7 is a diagrammatical representation of a digital composite image 74 of an overlay of the images 46 and 46A of FIGS. 3 and 4 registered in accordance with embodiments of the present technique, which facilitates comparison of images 46 and 46A acquired at different times by providing a novel method and apparatus for registration of images. The respective midpoints 56 and 56A of the temporal anomalies 50 and 50A in the illustrated exemplary registration of the images 46 and 46A are positioned at the same point in the composite image 74. Thus, in this embodiment, the Y-distance 76 and the X-distance 78 to the edges 58 and 60 of the composite image 74 from the two respective midpoints 56 and 56A are the same.

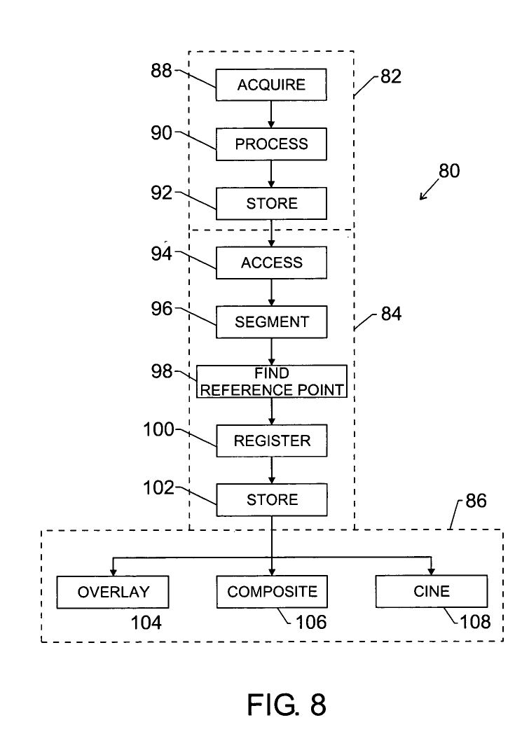

FIG. 8 is a block diagram of an image registration method 80. Initially, an imaging system (block 82) may be used to acquire, process, and store images or image data. An image handling system, such as a PACS, may be used to further manipulate (block 84) the image data to facilitate comparison of the images or image data, such as in the comparison of data collected at separate times. An interface (block 86), such as a personal computer or PACS workstation or monitor, may be used to display the images or image data for comparison.

One or more images may be acquired (block 88) with various imaging systems, such as those previously discussed. The imaging systems may reconstruct and/or process (block 90) the acquired image data prior to storage (block 92). The data or images may be stored locally or remotely, for example, in a data repository in a medical facility network. Certain functional components of an exemplary imaging system may be in the form of a medical diagnostic imaging system. As described in FIG. 1, an imaging system generally includes some type of imager which detects signals and converts the signals to useful data, and regions of interest in a patient are created by the imager either in a conventional support, such as photographic film, or in a digital medium. For images acquired on conventional analog film, the images may be subsequently digitized for further processing.

The present technique may be employed to further manipulate (block 84) the stored image data, for example, to line up anomalies in images using computer recognition. Initially, for example, a clinician or system may access (block 94) the stored images or image data and segment (block 96) the images to identify boundaries and sizes of one or more features of interest, such as one or more anomalies. A segmentation algorithm or segmentation portion of a computer assisted detection (CAD) algorithm may identify a particular region of interest based upon calculated features in the tomographic data. The region of interest can be determined in a number of manners, using an entire data set or using part of a data set, such as a candidate mass region in a specific area. Again, the particular segmentation technique may depend upon the anatomies to be identified, and may typically be based upon a variety of extraction approaches, such as those previously discussed. The segmentation may be automated or at least partially manual, and may use prior knowledge such as shape and size of a mass to automatically delineate an area of interest.

Once segmented, the anomaly or feature may be sized to determine a reference point, such as the middle or midpoint (block 98). As will be appreciated by those skilled in the art, a variety of techniques are available to size an area or volume of a regular shape or irregular shape. Once sized, a location, such as the middle, center of mass, geometric center, centroid, midpoint, center, or some other point or region on the anomaly 50 and 50A may be determined. In general, an algorithm may be used to find, for example, the center of the feature, or some other location on the feature, using a variety of available techniques. For determination of the size and reference point location, the analyses may involve iterative algorithms that initially use calculations to approximate a starting point for the iteration and then subsequently converge on a more accurate or precise location. Additionally, the reference point or midpoint may be determined without first sizing the feature.

Once a location marker, such as the midpoint, has been determined, the images, such as the temporal images 46 and 46A of FIGS. 3 and 4 acquired at times t1 and t2, may be registered (block 100) or aligned based on the determined location, and thus facilitate, for example, a temporal change analysis of the region of interest (block 86). The registration, as represented by block 100, may be a rigid body registration transformation including, for example, translation, rotation, magnification, shearing, and so forth. On the other hand, the registration may be a warped registration, including, for example, elastic transformations through the use of multi-scale, multi-region, and pyramidal approaches. Or, the registration may be a combination of rigid body and warped registrations. Ultimately, in the current embodiment, the determined location marker, such as the midpoint 56 and 56A, provides a basis for the alignment or registration. After all, in this example, a focus of the radiologist or clinician is the anomaly 50 and 50A (a feature of interest). As previously discussed, a clinician's analysis of a feature of interest (such as the anomaly 50 and 50A) in multiple images, such as images 46 and 46A acquired at separate times, may be impeded without registration based on the feature of interest. A clinician's review and comparison of temporal change in a feature of interest, for example, by comparing images as an overlay or in stack mode (block 104), as a composite (block 106), or in cine mode (block 108) may be advanced by the present technique. The images may be compared before or after storage (block 102) of the registration data.

In sum, an aspect of the present technique is to register or align two or more images based on a location of a reference point, such as a midpoint, on a feature such as an anomaly, using automated or semi-automated techniques, computer-assisted techniques, manual techniques, and so forth. Such features might include lesions, sizes and shapes of particular anatomies or organs, and other features which would be discernable in the image based upon the skill and knowledge of the individual practitioner. Initially, to accomplish the registration, the anomaly or feature may be identified and sized to determine the location of the reference point such as the middle of the feature. It should be noted that “identification” in the present context may not encompass classification of the feature, but instead may include only segmentation or recognition of the feature and its edges or boundaries. In general, various programs that may draw upon raw or processed image data are available to identify features or structures. Such programs may include mathematically or logically-defined feature recognition steps, intensity or color-based feature detection, automated or semi-automated feature segmentation, and classification based upon comparisons of identified and segmented features with known characteristics of identified pathologies. For example, computer-assisted detection (CAD) algorithms or segmentation algorithms may selectively extract a feature from its background by identifying the features of interest by reference to known or anticipated image characteristics, such as edges, identifiable structures, boundaries, changes or transitions in colors or intensities, changes or transitions in spectrographic information, and so forth. Selection of the particular segmentation algorithm may be based, for example, upon the type of feature to be identified, upon the imaging modality used to create the image data, and in anticipation of the subsequent types of registration (block 100) and display (block 86).

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for aligning images, comprising:
identifying a feature of interest in a first image;
identifying a corresponding feature of interest in a second image;
registering the feature of interest within the first image with the corresponding feature of interest within the second image; and
storing registration data corresponding to registration.

2. The method of claim 1, further comprising displaying the registration data.

3. The method of claim 2, wherein displaying the registration data comprises displaying a cine serial view of the first image and the second image.

4. The method of claim 2, wherein displaying the registration data comprises displaying an overlay of the first image and second image in stack mode.

5. The method of claim 2, wherein displaying the registration data comprises displaying a composite image of the first image and the second image.

6. A method for registering images, comprising:
segmenting a feature of interest in a first image;
segmenting a corresponding feature of interest in a second image;
registering the first image with the second image by aligning the feature of interest with the corresponding feature of interest; and
storing image data corresponding to registration.

7. The method of claim 6, wherein the first image and second image are acquired in different temporal settings.

8. The method of claim 6, wherein the first image and second image are acquired by the same modality.

9. The method of claim 6, wherein the first image and second image are acquired by different modalities.

10. The method of claim 6, wherein the first image and second image are X-ray images.

11. The method of claim 6, further comprising displaying the image data corresponding to registration.

12. The method of claim 11, wherein the image data is displayed in at least one of a cine serial display, an overlay in stack mode, and a composite image.

13. A method for registering images, comprising:
segmenting a feature of interest in a first image;
segmenting a corresponding feature of interest in a second image;
determining a first reference point on the feature of interest in the first image;
determining a second reference point on the corresponding feature of interest in the second image.
registering the first image with the second image based on alignment of the first reference point with the second reference point; and
storing registration data corresponding to registration.

14. The method of claim 13, further comprising displaying the registration data in at least one of a cine serial display, an overlay in stack mode, and a composite image.

15. The method of claim 13, wherein the feature of interest and the corresponding feature of interest are an anomaly.

16. The method of claim 13, wherein the first reference point is the middle of the feature of interest; and the second reference point is the middle of the corresponding feature of interest.

17. The method of claim 13, wherein the first image and the second image are acquired in different temporal settings.

18. The method of claim 13, wherein segmenting is automated.

19. The method of claim 13, wherein registering is automated.

20. The method of claim 13, further comprising determining additional reference points and registering the first image with the second image based on the additional reference points.

21. A method for anchoring images, comprising:
identifying and sizing a feature of interest in a first image;
identifying and sizing a corresponding feature of interest in a second image;
locating a first reference point on the feature of interest;
locating a second reference point on the corresponding feature of interest;
registering the first image with the second image based on anchoring the first reference point with the second reference point; and
storing registration data corresponding to registration.

22. The method of claim 21, wherein one or more computer aided techniques are used to identify and size the feature of interest and the corresponding feature of interest.

23. The method of claim 21, wherein the feature of interest and the corresponding feature of interest are manually identified.

24. The method of claim 21, wherein the first reference point and the second reference point are location markers for the registration.

25. The method of claim 24, wherein registration comprises rigid body registration transformation.

26. The method of claim 25, wherein the rigid body registration transformation comprises at least one of a translation, a rotation, a magnification, and a shearing.

27. The method of claim 21, wherein registration comprises warped registration and at least one of an elastic transformation, a multi-scale approach, a multi-region approach, and a pyramidal approach.

28. The method of claim 21, wherein the registration comprises a combination of a rigid body registration and a warped registration.

29. The method of claim 21, further comprising accessing the registration data to compare the first image with the second image.

30. The method of claim 21, further comprising accessing the registration data to compare the feature of interest with the corresponding feature of interest.

31. The method of claim 30, further comprising displaying the registration data in at least one of a cine serial display, an overlay in stack mode, and a composite image.

32. A system for registering images comprising:
one or more imaging systems for acquiring and storing images;
a first interface for accessing, reviewing, processing, and registering the images;
a storage for storing image registration data; and
wherein registration of the images is based on alignment of corresponding features of interest in the images.

33. The system of claim 32, further comprising a second interface or monitor for displaying the registration data in at least one of a cine, a stack, an overlay, and a composite.

34. The system of claim 33, wherein the first interface and the second interface are the same interface and are a PACS workstation.

35. The system of claim 32, further comprising an analog to digital device or scanner for converting analog film images to digital images.

36. The system of claim 32, wherein the images are digital images and digitally-acquired images.

37. The system of claim 32, wherein the images are digitized images and scanned images.

38. The system of claim 32 wherein the one or more imaging systems are at least one of a conventional X-ray imaging system, a digital X-ray imaging system, a CT imaging system, and a MR imaging system.

39. A system for comparing images, comprising:
means for identifying a feature of interest in a first image;
means for identifying a corresponding feature of interest in a second image;
means for registering the feature of interest within the first image with the corresponding feature of interest within the second image; and
means for storing registration data corresponding to registration.

40. The system of claim 33, further comprising means for displaying the registration data.

41. The system of claim 40, further comprising means for displaying the registration data in at least one of a cine serial view, a stack mode, an overlay, and a composite.

42. A system for registering images, comprising:
means for segmenting a feature of interest in a first image;
means for segmenting a corresponding feature of interest in a second image;
means for registering the first image with the second image by aligning the feature of interest with the corresponding feature of interest; and
means for storing image data corresponding to registration.

43. The system of claim 42, further comprising means for displaying the image data corresponding to registration.

44. A system for aligning images, comprising:
means for segmenting a feature of interest in a first image;
means for segmenting a corresponding feature of interest in a second image;
means for determining a first reference point on the feature of interest in the first image;
means for determining a second reference point on the corresponding feature of interest in the second image;
means for registering the first image with the second image based on alignment of the first reference point with the second reference point;
means for storing registration data corresponding to registration; and
means for displaying the registration data.

45. A computer program, provided on one or more tangible media, for registering images, comprising:
a routine for identifying a feature of interest in a first image;
a routine for identifying a corresponding feature of interest in a second image;
a routine for registering the feature of interest within the first image with the corresponding feature of interest within the second image; and
a routine for storing registration data corresponding to registration.

46. The computer program of claim 45, further comprising a routine for displaying the registration data.

47. The computer program of claim 46, further comprising a routine for displaying the registration data in at least one of a cine serial view, a stack mode, an overlay, and a composite image.

48. A computer program, provided on one or more tangible media, for comparing images, comprising:
a routine for segmenting a feature of interest in a first image;
a routine for segmenting a corresponding feature of interest in a second image;
a routine for registering the first image with the second image by aligning the feature of interest with the corresponding feature of interest; and
a routine for storing image data corresponding to registration.

49. The computer program of claim 48, further comprising a routine for displaying the image data corresponding to registration.

50. A computer program for aligning images, comprising:
a routine for segmenting a feature of interest in a first image;
a routine for segmenting a corresponding feature of interest in a second image;
a routine for determining a first reference point on the feature of interest in the first image;
a routine for determining a second reference point on the corresponding feature of interest in the second image;
a routine for registering the first image with the second image based on alignment of the first reference point with the second reference point;
a routine for storing registration data corresponding to registration; and
a routine for displaying the registration data.
